(19) United States
(12) Patent Application Publication
(10) Pub. No.: US 2022/0154964 A1
(43) Pub. Date: May 19, 2022

(54) Artificial Breeze System

(71) Applicant: Mumarba LLC, Austin, TX (US)

(72) Inventor: Reddiah B. Mummaneni, Austin, TX (US)

(21) Appl. No.: 17/405,295

(22) Filed: Aug. 18, 2021

Related U.S. Application Data
(60) Provisional application No. 63/114,099, filed on Nov. 16, 2020.

(51) Int. Cl. F24F 11/65; G05B 15/02; F24F 11/00

(52) U.S. Cl. CPC F24F 11/65; F24F 11/0001; G05B 15/02

(57) ABSTRACT

Devices, systems, and methods for an artificial breeze system. A processor transmits actuation signals to two or more fans located at different locations. The actuation signals cause the two or more fans to generate respective flows of air that vary over time. The combination of the respective flows of air produces an aggregate flow of air with an apparent point of origin that varies over time.

### PRIORITY CLAIM

This application claims priority to U.S. Provisional Patent Application No. 63/114,099, titled “Artificial Breeze System” and filed on Nov. 16, 2020, which is hereby incorporated by reference in its entirety, as though fully and completely set forth herein.

### FIELD

The present application relates to fan devices, and more particularly to apparatus, systems, and methods for an artificial breeze device to emulate natural wind phenomena.

### DESCRIPTION OF THE RELATED ART

Fans and other air blowing devices generally work at preset speeds to produce a steady flow of air. However, improvements in the field are desired.

### SUMMARY

Embodiments relate to systems and methods for producing a natural wind phenomenon. More specifically, embodiments may relate to a fan or air blowing device that generates air which more closely approximates a natural breeze, thus providing improved comfort and an overall improved user experience

According to some embodiments, actuation signals are sent to two or more fans to create an aggregate air flow that is experienced by a user at a first location as coming from different points of origin. In some embodiments, the speed and/or direction or the two or more fans may be coordinated such that, from a first location within blowing range of the two or more fans, the aggregate air flow experienced by a person at the first location varies in its direction.

The techniques described herein may be implemented in and/or used with a number of different types of devices and systems, including but not limited to fan devices, cooling systems, computer software for cellular phones, tablet computers and/or wearable computing devices, integrated home environment systems, and any of various other systems and devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 is an overhead room layout including four fans and a user, according to some embodiments;

FIG. 2 is a flowchart diagram illustrating a method for creating an aggregate air flow, according to some embodiments; and

FIG. 3 shows a basic computing device block diagram, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Portable Memory Device—Any of various types of physical media containing a memory medium, wherein the portable memory device is configured to communicate with a computing device to receive and transmit data from the memory medium. Examples of portable memory devices include universal serial bus (USB) drives, or “thumb drives”, portable hard drives, and other types of portable memory media.

Carrier Medium—a memory medium as described above, as well as a physical transmission medium, such as a bus, network, and/or other physical transmission medium that conveys signals such as electrical, electromagnetic, or digital signals.

Processing Element—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, PASCAL, FORTRAN, COBOL, JAVA, assembly language, etc.; graphical programs (programs written in graphical programming languages); assembly language programs; programs that have been compiled to machine language; scripts; and other types of executable software. A software program may comprise two or more software programs that interoperate in some manner. Note that various embodiments described herein may be implemented by a computer or software program. A software program may be stored as program instructions on a memory medium.

Hardware Configuration Program—a program, e.g., a netlist or bit file, that can be used to program or configure a programmable hardware element.

Program—the term “program” is intended to have the full breadth of its ordinary meaning. The term “program” includes 1) a software program or application which may be stored in a memory and is executable by a processor or 2) a hardware configuration program useable for configuring a programmable hardware element.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™ PlayStation Portable™, Gameboy Advance™, iPhone™), laptops, wearable devices (e.g. smart watch, smart glasses), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication. A UE device may be configured to communicate according to various wireless access technologies, including but not limited to cellular communications, Wi-Fi or wireless local area network WLAN communications, short-range wireless access technologies such as Bluetooth, global positioning satellite (GPS) or other global navigational satellite technologies, among other possibilities.

Measurement Device—includes instruments, data acquisition devices, smart sensors, and any of various types of devices that are configured to acquire and/or store data. A measurement device may also optionally be further configured to analyze or process the acquired or stored data. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more DAQ or measurement cards or modules in a chassis. The measurement device may be equipped with one or more sensors for performing electromyographic measurements on a human subject to measure muscle activity, in some embodiments.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Artificial Breeze System

Air flow created by synthetic systems such as fans or blowers generally operate at preset speeds and produce a steady flow of air. This is different from how breeze in the natural environment is felt and perceived by the human body. For one, natural breeze is intermittent, allowing the body to sweat and then experience subsequent gusts, which create the phenomenon of evaporation, allowing the body to cool down. In addition to the intermittent nature of natural gusts, there is also the phenomenon of directionality which varies in natural environments. The variation may result from the reflection of wind off of surfaces and/or it may arise as the air flows through natural environments such as trees, hills, etc.

Embodiments herein present a control and actuation system comprised of software, a computing device, and two or more fans or blower systems all connected through wired and/or wireless connections.

In one embodiment, the computing device includes a controller that may be programmed to produce natural wind phenomena by activating a fan motor at variable speeds, variable times, and by actuating a directional mount on which the fan is situated.

In another manifestation, multiple fans or blowers are situated at various locations in a space, and a single control mechanism actuates each of these fans or blowers in a coordinated fashion, varying the speed, timing, and/or directionality of each fan or blower.

In some embodiments, the control mechanism may be modified to emulate (e.g., artificially create or replicate) natural wind conditions in different areas. For example, a sea breeze may be created/emulated or replicated, or the breeze patterns in a mountain hill resort may be created/emulated or replicated.

Control inputs may be provided via a remote control unit, a wired unit, and/or by software (e.g., an app) that runs on cell phones or tablets.

In some embodiments, the systems described may be integrated with a home environmental control system so that a central computer or environmental program can actuate the functioning of said system.

In some embodiments, a real-world breeze recording system may be implemented. This recording system may be a system that can be placed outside that includes wind sensors, an embedded computer, and/or requisite software. The breeze monitoring may be performed by wind vanes and wind direction sensors that would measure both the directionality and speed of gusts as a function of time. They would also measure the timing between gusts, and capture all of this information in a time series data format. The recorded wind patterns may be reproduced by the artificial breeze system based on the recording. Alternatively, or additionally, the recorded wind data may be fed to a machine learning system that learns the underlying patterns and recreates them with some degree of randomness, so that the actuation of fan motors is not repeated exactly, creating new and novel breeze experiences for the end user.

### Health Benefits of Artificial Breeze System

Embodiments described herein may produce improved health outcomes through their interaction with skin sensory receptors and the cooling system of the body.

A light breeze, or zephyr, feels comfortable because the zephyr evaporates light sweat that is formed on the skin and elicits a sensation on the skin. The sensation of comfort elicited by the breeze may result in part from activation of the sensory receptors in the skin by the breeze coming in from different directions and at different rates. If the airflow is always from a single direction, like from a ceiling fan or a table fan, the sensory receptors become hyper-polarized and desensitized and reduce their transmission of the wind sensation to the brain. This is a similar mechanism as what happens when a person does not feel the heat from (moderately) hot water the longer he keeps his hand in the water.

If there is a constant temperature in the environment, the natural cooling systems of the body (e.g. the sweat systems) may cease or reduce operations to maintain a steady temperature in the human body. When sweat systems are not activated, ripple effects on other body systems such as thirsts mechanisms may occur. In other words, since we are not sweating, we may not experience enough thirst to cause us to consume adequate water, which effects our hydration. Not drinking sufficient water may have severe consequences such as adversely affecting the gastrointestinal system, causing constipation.

Embodiments herein improve health outcomes through stimulation of both our sensory perception and sweat systems. For example, randomness of the direction of airflow causes the sensory receptors in the skin to not become hyper-polarized so that we continue to feel the sensation of the breeze on the skin for an extended duration of time. Additionally, varying the rate of the airflow gives time for the sweat glands to form a thin layer of sweat on the skin which, when evaporated by a subsequent breeze, feels comfortable and activates our natural cooling systems.

As the natural cooling systems of the body are engaged, the ambient temperature of the environment may be raised significantly to allow a person/user to feel comparably comfortable. For example, by emulating a natural breeze environment that activates natural human cooling systems more effectively, a user may be able to maintain a desired level of comfort at a higher ambient temperature. This in turn may help to save significant energy by raising the temperature on the thermostats of air conditioners in the space, since they are less needed. In other words, the cooling systems described herein may produce a desired level of comfort for a particular user at a higher temperature than would be required by a cooling system that does not effectively activate our sensory perception and cooling systems (i.e., a cooling system that is static in one or more of wind speed and direction).

Significant energy is spent to maintain a constant body temperature. For example, a large amount of energy is spent producing the sweat to cool the body. This energy is spent automatically in the background of our biological systems, and activating our cooling systems raises our basal metabolic rate. If this energy is not spent then it may be converted into a storage form in the body, i.e., body fat. Accordingly, in some embodiments the described artificial breeze systems may assist in reducing obesity.

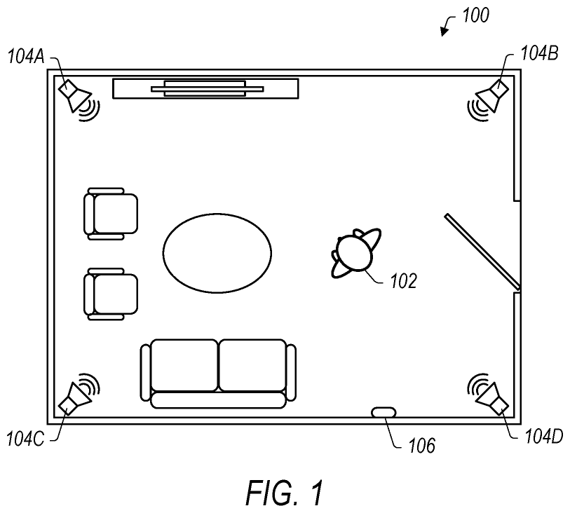

### FIG. 1—Overhead Floor Plan

FIG. 1 is an overhead floor plan of a room containing four fans, according to some embodiments. As illustrated, four fan devices 104A-D are situated in four different corners of a room. The number and location of the fan devices in FIG. 1 is exemplary only, and other numbers and/or locations of the fan devices are also possible. A user 102 is located in the room. As described in greater detail herein, in some embodiments, actuation signals are sent to each of the four fan devices to cause the fan devices to create respective air flows that vary in time. The air flows may vary in speed and/or direction (e.g., through rotatable mounts on the fan devices). The respective air flows of the fan devices may combine to create an aggregate air flow experienced at the location of the user (as well as other locations). For example, the aggregate air flow may be a vector summation of each of the individual air flows (e.g., for laminar flow) or a more complex non-linear combination of the individual air flows (e.g., for non-laminar or turbulent flow) as experienced at the location of the user. The actuation signals may be sent to the four fan devices in a coordinated fashion, such that the user 102 experiences an aggregate air flow that blows on the user from different directions and/or with different speeds at different points in time. In other words, the apparent or perceived point of origin of the aggregate air flow may vary over time, e.g., by changing the relative speeds and/or directions of each the four fan devices. Advantageously, this may create an experience for the user more similar to a natural wind environment. For example, from the location of the user 102, the aggregate air flow may change direction such that it appears to originate from different locations throughout the room over time.

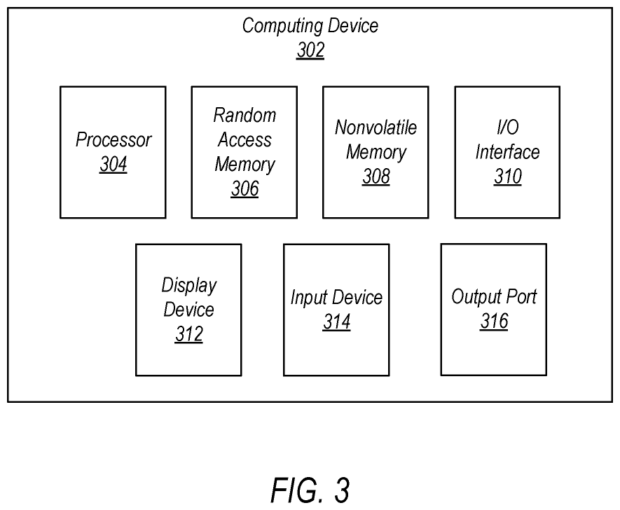

FIG. 1 additionally illustrates a control panel 106 that may include a user interface for controlling the fan system. The control panel 106 may include a computing device similar to that shown in FIG. 3, and may be configured to provide the actuation signals to control the fans 104A-D using either a wired or wireless connection. For example, the control panel may be similar to a thermostat in some respects, in that it includes a display and a touch screen that may receive input from a user to control the fan system. Alternatively, software may be installable as an app on a smartphone or tablet for the user to control the fan system.

While FIG. 1 illustrates a rectangular room with four fan devices located in the four corners of the room, embodiments herein may be applied to different types of spaces (e.g., corridors, outdoor areas, stadiums, etc.) of different shapes and with different number of fan devices at different locations, etc.

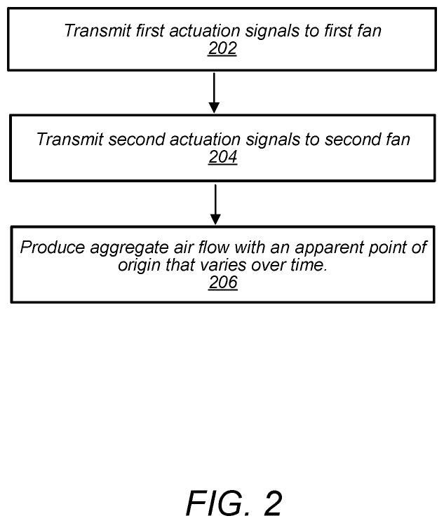

### FIG. 2—Flowchart for Emulating Natural Wind

FIG. 2 is a flowchart diagram illustrating a method for emulating natural wind, according to some embodiments. a processor configured to communicate with two or more fans. The methods described in reference to FIG. 2 may be performed by a fan system including two or more fans and a computing device. The computing device may include a processor couple to a non-transitory computer-readable memory medium. The memory medium may store program instructions which, when executed by the processor, cause the fan system to implement the described method steps. The processor may be integrated with a home environmental control system. More generally, the method shown in FIG. 2 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

At 202, first actuation signals are transmitted to a first fan of fan system to create a first flow of air that varies over time. The first actuation signals may cause the first fan to create a first flow of air that varies in one or both of speed and direction.

At 204, second actuation signals are transmitted to a second fan of the fan system to create a second flow of air that varies over time. The second actuation signals may cause the second fan to create a second flow of air that varies in one or both of speed and direction. The first and second actuation signals may be transmitted to the two or more fans via the processor via a wired or wireless connection. In some embodiments, one or more additional actuation signals may be transmitted to one or more additional respective fans of the fan system. For example, the fan system may include three, four or more fans that are distributed throughout a room, corridor, or other location, and each of the fans may be configured to receive respective actuation signals.

At 206, the combination of the first and second flows of air produces an aggregate air flow with an apparent point of origin that varies over time. The apparent point of origin of the aggregate air flow may be understood to refer to a direction of origin of the aggregate air flow (e.g., from a particular corner of the room) as perceived from a first location (e.g., the center of a room) within blowing range of the two or more fans. The first and second flows of air may vary over time by varying in one or both of direction and speed over time. The first and second actuation signals may further cause the two or more fans to turn on and off with an irregular period.

In some embodiments, the two or more fans are situated at different locations within a room and the first and second actuation signals coordinate the behavior of each of the two or more fans to move the apparent point of origin of the aggregate air flow (as perceived from a first location) around the room. As one example, a person in the room may initially perceive an aggregate flow of air coming predominantly from the direction of the first fan (e.g., because the first fan initially operates at a relatively high speed while the second fan initially operates at a relatively low speed). Over time, the first fan may decrease its speed and the second fan may increase its speed, such that the aggregate flow of air felt by the person from the first location may smoothly transition from appearing to originate from the first fan to appearing to originate from the second fan. In other words, the perceived origin of the aggregate air flow for the person may move from the location of the first fan toward the location of the second fan. Advantageously, by changing the direction from which a person experiences air flow, the person's natural cooling systems may be more effectively activated.

In some embodiments, four fans are placed in different corners of a room, and the four fans may coordinate changes in their respective fan speeds such that the aggregate air flow in the center of the room has an apparent point of origin that moves between the locations of each of the four fans. In other words, over time a person in the center of the room may feel air flow coming from all four cardinal directions in a randomly changing pattern. The aggregate air flow may vary in both its direction and its speed over time. Additionally, or alternatively, the aggregate air flow (as perceived from a first location) may vary in its direction in the vertical direction as well in the horizontal direction. For example, the fans may be located at different heights around the room such that the aggregate air flow that has an apparent point of origin that varies in height over time.

In some embodiments, the processor is configured to receive user input selecting a natural wind environment. In response to the user input, the processor may generate the first and second actuation signals, where the first and second actuation signals cause the aggregate flow of air to approximate the natural wind environment. The natural wind environment may be one of a plurality of selectable natural wind environments stored on the memory medium, such as an ocean breeze pattern, a mountain breeze pattern, a canyon breeze pattern or a plains breeze pattern, among other possibilities.

In some embodiments, the system further includes one or more sensors configured to measure wind movement. The sensors may be used to record wind movement in an outdoor environment, where the recorded wind movement specifies a velocity of wind over time. The recorded wind movement may be stored in memory and used to select the first and second actuation signals to cause the one or more fans to emulate the recorded wind movement. The recorded wind movement may include directionality of wind, the speed of wind, and/or timing between gusts of wind.

In some embodiments, the recorded wind movement may be input to a machine learning algorithm. The machine learning algorithm may be used to modulate the recorded wind movement with a degree of randomness and may be used to derive actuation signals for the two or more fans to reproduce a modified wind movement.

In some embodiments, the fan system further comprises one or more sensors configured to detect a location of a person within blowing range of to the two or more fans. In these embodiments, actuation signals may be generated based at least in part on the location of the person, where the actuation signals are generated such that the apparent point of origin of the aggregate flow of air varies at the detected location of the person. For example, the actuation signals may be modified based on the detected location of the person in a room, such that the aggregate air flow at that location changes direction over time.

### FIG. 3—Computing Device

FIG. 3 is a schematic illustration of a computing device that may be configured to implement embodiments described herein.

As shown in FIG. 3, the computing device 302 may include a processor, random access memory (RAM), nonvolatile memory, a display device, an input device, an I/O interface, and/or an output port for transmitting actuation signals to fans of a fan system. For example, the computing device 302 may include at least one memory medium on which one or more computer programs or software components according to one embodiment of the present invention may be stored. For example, the memory medium may store one or more programs that are executable to perform the methods described herein. The memory medium may also store operating system software, as well as other software for operation of the computer system.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A system, comprising:
a processor configured to communicate with two or more fans; and
a non-transitory computer-readable memory medium coupled to the processor, wherein the non-transitory computer-readable memory medium stores program instructions which, when executed by the processor, cause the system to:
transmit first actuation signals to a first fan of the two or more fans to create a first flow of air that varies over time;
transmit second actuation signals to a second fan of the two or more fans to create a second flow of air that varies over time, wherein a combination of the first and second flows of air produces an aggregate air flow with an apparent point of origin that varies over time.

2. The system of claim 1,
wherein the apparent point of origin of the aggregate air flow comprises a perceived point of origin of the aggregate air flow from a first location within blowing range of the two or more fans.

3. The system of claim 1,
wherein the first and second flows of air varying over time comprises the first and second flows of air varying in one or both of direction and speed over time.

4. The system of claim 1,
wherein the first and second actuation signals further cause the two or more fans to turn on and off with an irregular period.

5. The system of claim 1,
wherein the processor is configured to receive user input selecting a natural wind environment,
wherein, in response to the user input, the processor is configured to generate the first and second actuation signals, wherein the first and second actuation signals cause the aggregate flow of air to approximate the natural wind environment.

6. The system of claim 5,
wherein the natural wind environment comprises one of a plurality of selectable natural wind environments stored on the memory medium, wherein the plurality of selectable wind environments comprise one or more of:
an ocean breeze pattern;
a mountain breeze pattern;
a canyon breeze pattern; and
a plains breeze pattern.

7. The system of claim 1,
wherein the first and second actuation signals are transmitted to the two or more fans via a wired or wireless connection.

8. The system of claim 1,
wherein the processor is integrated with a home environmental control system.

9. The system of claim 1, the system further comprising:
one or more sensors configured to measure wind movement, wherein the system is further configured to:
record wind movement in an outdoor environment, wherein the recorded wind movement specifies a velocity of wind over time, and wherein the first and second actuation signals cause the one or more fans to emulate the recorded wind movement.

10. The system of claim 9,
wherein recording the wind movement comprises recording one or more of the directionality of wind, the speed of wind, and timing between gusts of wind.

11. The system of claim 1, the system further comprising:
one or more sensors configured to measure wind movement, wherein the system is further configured to:
record wind movement in an outdoor environment,
input the recorded wind movement to a machine learning algorithm;
receive modified wind movement from the machine learning algorithm, wherein the modified wind movement comprises an approximation of the recorded wind movement modulated by a degree of randomness, wherein the first and second actuation signals cause the one or more fans to reproduce the modified wind movement.

12. The system of claim 1, the system further comprising:
one or more sensors configured to detect a location of a person within blowing range of to the two or more fans;
where in the program instructions are further executable by the processor to cause the system to:
generate the first and second actuation signals based at least in part on the location of the person, wherein the first and second actuation signals are generated such that the apparent point of origin of the aggregate flow of air varies at the location of the person.

13. A fan system, comprising:
two or more fans, wherein the two or more fans are configured to:
receive, by a first fan of the two or more fans, first actuation signals causing the first fan to create a first flow of air that varies over time;
receive, by a second fan of the two or more fans, second actuation signals causing the second fan to create a second flow of air that varies over time, wherein a combination of the first and second flows of air produces an aggregate flow of air with an apparent point of origin that varies over time.

14. The fan system of claim 13,
wherein the apparent point of origin of the aggregate flow of air is a perceived point of origin of the aggregate flow of air from a first location within blowing range of the two or more fans.

15. The fan system of claim 13,
wherein the first and second flows of air varying over time comprises the first and second flows of air varying in one or both of direction and speed over time.

16. The fan system of claim 13,
wherein the first and second actuation signals further cause the two or more fans to turn on and off with an irregular period.

17. The fan system of claim 13,
wherein the two or more fans are situated at different locations within a room, and
wherein the first and second actuation signals coordinate the behavior of each of the two or more fans to move the apparent point of origin of the aggregate air flow around the room.

18. The fan system of claim 13, further comprising:
a processor configured to provide the first and second actuation signals through a wired or wireless connection.

19. The fan system of claim 13,
wherein the two or more fans comprise a third fan and a fourth fan,
wherein the third fan is configured to receive third actuation signals to create a third flow of air that varies over time,
wherein the fourth fan is configured to receive fourth actuation signals to create a fourth flow of air that varies over time,
wherein the aggregate flow of air comprises a vector summation of the first, second, third and fourth flows of air, and
wherein the first, second, third and fourth fans are distributed in different corners of a room.

20. A non-transitory computer-readable memory medium comprising program instructions which, when executed by a processor, cause the processor to:
transmit first actuation signals to a first fan to create a first flow of air that varies over time;
transmit second actuation signals to a second fan to create a second flow of air that varies over time, wherein a combination of the first and second flows of air produces an aggregate air flow with an apparent point of origin that varies over time,
wherein the apparent point of origin of the aggregate air flow comprises a perceived point of origin of the aggregate air flow from a first location within blowing range of the two or more fans.
